(19) United States
(12) Patent Application Publication
(10) Pub. No.: US 2007/0268800 A1
(43) Pub. Date: Nov. 22, 2007

(54) Optical Disc, Player for the Optical Disc and Its Player Back Method

(76) Inventors: Yang Peng, Shanghai (CN); Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/578,374

(22) PCT Filed: Nov. 7, 2004
(86) PCT No.: PCT/IB04/52325

§ 371 Date: May 3, 2007

(30) Foreign Application Priority Data
Nov. 10, 2003 (CN) 200310116101.7

(51) Int. Cl. G11B 27/10

(52) U.S. Cl. 369/47.34

(57) ABSTRACT

An optical disc player includes an explaining device and a buffering management device. The explaining device is used to explain a command document; and the buffering management device is used to obtain the auxiliary information in advance according to the explained command document to cooperate to play of the main information of the optical disc subsequently. The method of playing an optical player includes the steps: explaining a command document; reading an auxiliary information in advance according to the explained command document to cooperate to play corresponding main information of the optical disc; and playing the corresponding main information cooperating with the auxiliary information read in advance when the auxiliary information is needed.

### FIELD OF THE INVENTION

The present invention relates to an optical disc, optical disc player and the playing method thereof.

### BACKGROUND OF THE INVENTION

With the rapid development of optical disc and optical disc playing technology, more and more content suppliers of optical disc, when making the content of optical disc, provide other information (referred to as auxiliary information) to enhance entertainment and playing effect. The auxiliary information is stored on the optical disc separately from the main information, or stored on the network server, namely it is not multiplexed into the code stream of main information. The auxiliary information stored on the network server can be updated timely, thus it will provide the user more entertainment and better playing performance as well as reduce the burden on disc storage.

The auxiliary information of optical disc usually can not be obtained until the editing of main information is finished, for example, it is provided by other cooperators or edited according to the subsequent information. If this information is edited therein when editing the main information of the optical disc, it may possibly result in the imperfection of auxiliary information.

As shown in FIG. 1, the optical disc 10 stores the main information in the main information region 11, and auxiliary information in the auxiliary information region 12, and such storage method is not only convenient and simple, but also improves the entertainment and the playing performance.

Further, in the process of playing the main information of optical disc, it is logically divided into one or more Playlists to be played in sequence, and auxiliary information may need to be inserted at particular location or time of each Playlist to cooperate to play.

Auxiliary information usually comprises playlist ID corresponding to the main information of optical disc 10 (defining the number of the playlist), the time, address and link, etc., of the auxiliary information in the Playlist. The auxiliary information is synchronized in time with the main information of optical disc, and is also compatible in content. At each position of the main information of the optical disc where the auxiliary information is needed to cooperate with, corresponding URL is defined to link with the corresponding auxiliary information.

The aforesaid auxiliary information usually comprises JAVA (or C language or other computer language) application program, audio, subtitle, picture, animation or web page. Furthermore, such auxiliary information has not been multiplexed into the code stream of main information, and does not multiplex with the code stream of main information in playing. It only needs to be read into the buffer of the player and be played cooperating with the main information of the optical disc. Usually, there are many kinds of optical disc used to store the auxiliary information mentioned above, e.g. Blue-ray Disc, enhanced DVD, etc.

However, in playing optical disc, the player not only needs to read the main information stored in Main Information Region on the optical disc, but also has to move the optical head constantly to read the auxiliary information in Auxiliary Information Region of the optical disc. The optical head is moved so frequently to realize playing that the playing is obviously not fluent and even may be interrupted, which may influence the user's interest in viewing the optical disc information.

In addition, when the auxiliary information is downloaded from the network server to the player, and the downloaded auxiliary information is with the information read out directly from the optical disc (i.e. playing the optical disc while downloading). The downloaded auxiliary information may possibly be lagged with respect to the information read out directly from the optical disc since the network quality of service (QoS) can hardly be guaranteed, thus, it is hard to realize seamless playing. In particular, when the speed and bandwidth of network is no t enough, it will become even harder to realize seamless playing, and phenomena such as interruption or mismatch between picture and audio may arise which may influence the user's interest in viewing the optical disc information.

To solve the foregoing problems, prior to cooperating to play the main information of the optical disc, the auxiliary information need s to be downloaded and the auxiliary information in Auxiliary Information Region is downloaded completely or read into the player buffer, and then is played cooperating with the main information of the optical disc subsequently. However, this is accompanied with other trouble. On one hand, the user has to wait and can not view the disc information until the auxiliary information is completely read into the buffer, and it will obviously influence the user's eagerness to view the disc information. On the other hand, the buffer with limited space may not accommodate all such information.

Therefore, an optical disc, optical disc player and play back method thereof are needed to avoid the drawbacks mentioned above.

### SUMMARY OF THE INVENTION

According to the present invention, there is provided a kind of optical disc playing method and player for inputting the auxiliary information into a buffering management device in advance by explaining command document. The command document refers to a kind of document edited by XML or other languages, which comprises the time and location to play auxiliary information as well as the time to be read into the buffering management device.

Further, an optical disc with command document is provided according to the present invention.

The method for playing optical disc is provided in the invention, including the steps of: explaining a command document; reading an auxiliary information in advance according to the explained command document to cooperate to play corresponding main information of the optical disc; and playing the corresponding main information cooperating with the auxiliary information read in advance when the auxiliary information is needed.

The player described in the present invention comprises an explaining device and a buffering management device. Wherein, the explaining device is used to explain a command document, while the buffering management device for obtaining the auxiliary information in advance according to the explained command document to cooperate to play the main information of the optical disc subsequently.

The optical disc described in the present invention includes the main information and the auxiliary information stored separately from the main information, and is characterized in that the optical disc also includes a part for instructing to play the auxiliary information cooperating with the main information.

The optical disc, optical disc player and the playing method thereof described in the present invention explain s the command document stored on the optical disc and instructs during the playing to input the auxiliary information into a buffering management device in advance. Then play the auxiliary information cooperating with the main information of the optical disc, and thereby provides a fluent playing process.

The other aims and achievements of the present invention and the complete understanding of the invention will become clearer and more apparent by referring to the following description and claims taken in conjunction with the accompanying drawings.

### BRIEF DESCRIPTION OF THE DRAWINGS

The present invention will now be described in detail by means of example and with reference to the attached schematic drawings, wherein:

FIG. 1 shows a schematic view of the structure of the conventional optical disc;

FIG. 2 shows a schematic view of the structure of a command document of an optical disc according to an embodiment of the invention;

FIG. 3 shows a schematic view of the structure of a player according to an embodiment of the invention;

FIG. 4 shows a playing flow chart of an embodiment according to the invention.

In all the above drawings, like numbers refer to like or corresponding features and functions.

### PREFERRED EMBODIMENTS OF THE INVENTION

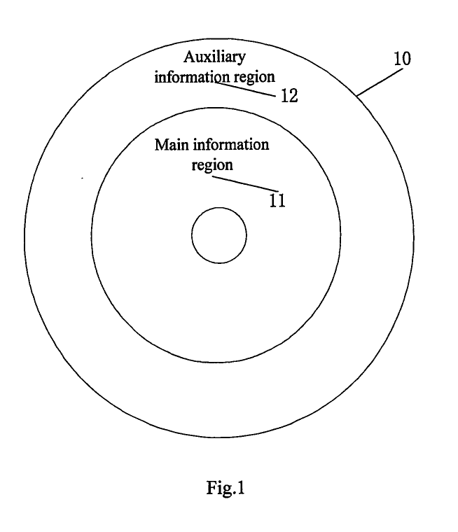

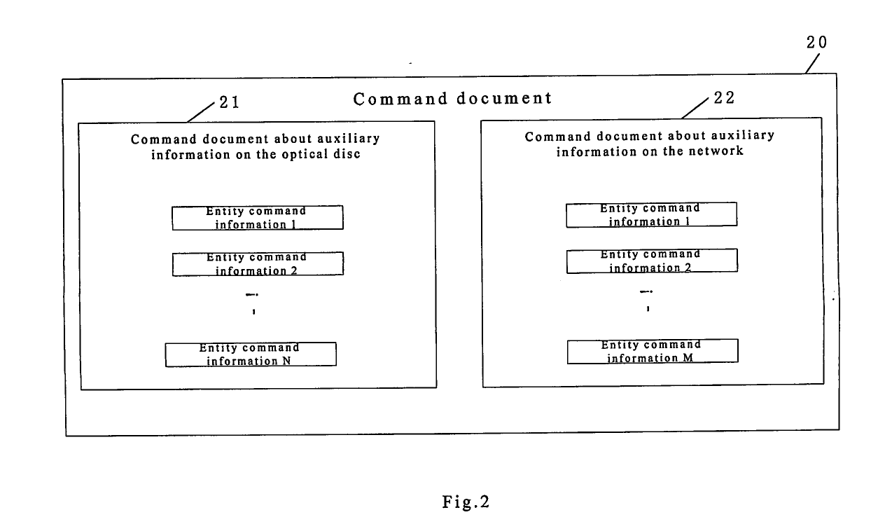

FIG. 2 shows the logic structure of a command document 20, wherein the command document 20 is edited by XML or other languages and is stored on the optical disc 10 (shown in FIG. 1) or a network server (not shown).

Command document 20 comprises the command document 21 with respect to the auxiliary information of the optical disc and the command document 22 with respect to the auxiliary information on the network. Wherein, the command document 21 with respect to the auxiliary information on the optical disc is mainly edited for the auxiliary information stored on the auxiliary information region 12 of the optical disc, while the command document 22 with respect to the auxiliary information on the network is edited for the auxiliary information stored on the network server (not shown here).

The command document 21 with respect to the auxiliary information on the optical disc includes one or more pieces of entity command information, e.g. entity command information 1, entity command information 2, and up to entity command information N. Each of the entity command information is used to describe the auxiliary information for coordination of playing the main information of the optical disc, e.g. animation, JAVA application, game, and other information mentioned in the background art of the invention.

Each of the entity command information includes an ID of a playing list when the corresponding auxiliary information is played in coordination with the main information, the time for reading or downloading the auxiliary information described by the entity command information into a buffering management device, the time for clearing the auxiliary information from the buffering management device, the URL of the auxiliary information (the URL corresponding to the information stored on the network server or the URL of the auxiliary information stored in the auxiliary information region on the optical disc), the time of the auxiliary information actually used for playing, and the size of the auxiliary information.

In addition, each of the entity command information also includes the auxiliary information URL used as a backup, the strategy for solving the problems that the speed of network is not fast enough or the network is blocked (e.g. waiting to retry, giving up or switching to the auxiliary information or backup auxiliary information matching with the network speed, which will be described in detail in the following), and the strategy for solving the problem that the speed of the player is not fast enough (e.g. switching to the backup auxiliary information matching with the speed of the player, which will be described in detail in the following).

The time to read or download the auxiliary information described by the entity command information into the buffer is any time before playing the auxiliary information, while the time to clear the auxiliary information is any time after playing the auxiliary information.

The information included in the command document 22 with respect to the auxiliary information on the network is substantially similar to the information included in the command document 21 with respect to the auxiliary information on the optical disc, and it is not described in detail here. The difference lies in that when playing the optical disc, if it is not connected to the network, the player will omit explaining the command document 22 with respect to the auxiliary information on the network (to be described in the following).

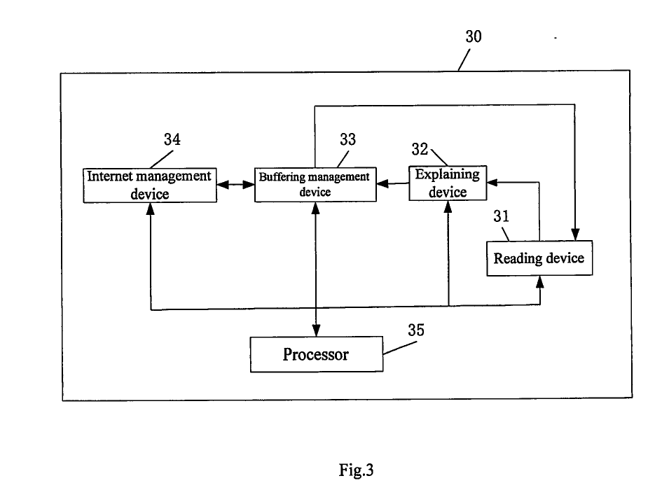

FIG. 3 show the schematic of the structure of an embodiment of the player according to the invention. The player 30 comprises reading device 31, explaining device 32, buffering management device 33, network management device 34 and processor 35. Wherein, the processor 35 is used to support the working process of other elements of the player 30.

The reading device 31 is used to read out the main information, the auxiliary information, and the command document 20 (shown in FIG. 2) on the optical disc, etc. The explaining device 32 is used to explain the command document 20 read by the reading device 31, and send instructions to input (including reading directly from the auxiliary information region of the optical disc and downloading from the network server, which are generally referred to as “input”) the auxiliary information into the buffering management device 32 according to the explained command document 20. The instruction usually includes the information contained in the entity command information shown in FIG. 2.

The buffering management device 33 is used to obtain and store the corresponding auxiliary information in advance according to the instruction of inputting auxiliary information sent by the explaining device 32, so that the auxiliary information can be read from the explaining device 31 when it is needed to cooperate to playof the main information of the optical disc. The buffering management device 32 is also used to clear timely the played auxiliary information according to the instruction sent by the explaining device 32. Of course, the auxiliary information obtained by the buffering management device 33 includes the auxiliary information read from the auxiliary information region of the optical disc and the auxiliary information downloaded from the network management device 34.

The network management device 34 is used to detect whether the player 30 is connected to the network, and if the player is not connected to the network it will inform the explaining device 32 not to process the command document 22 with respect to the auxiliary information of the network in the command document 20 (shown in FIG. 2). Therefore, the buffering management device 33 will not require the network management device 34 to download the corresponding auxiliary information.

Also, the network management device is used to detect whether there is new command document 20 stored on the network server, and if there is no new command document on the network server, the explaining device 32 explains the old command document 20 in the optical disc; if there is updated command document 20, the network management device 34 will download the updated command document and the explaining module 33 will explain the updated command document 20. The reason for the existence of the updated command document 20 lies in that once the optical disc is sold, the content supplier of the optical disc or other cooperators authorized by the content supplier may supply a lot of new auxiliary information to provide the user more entertainment or better playing effect.

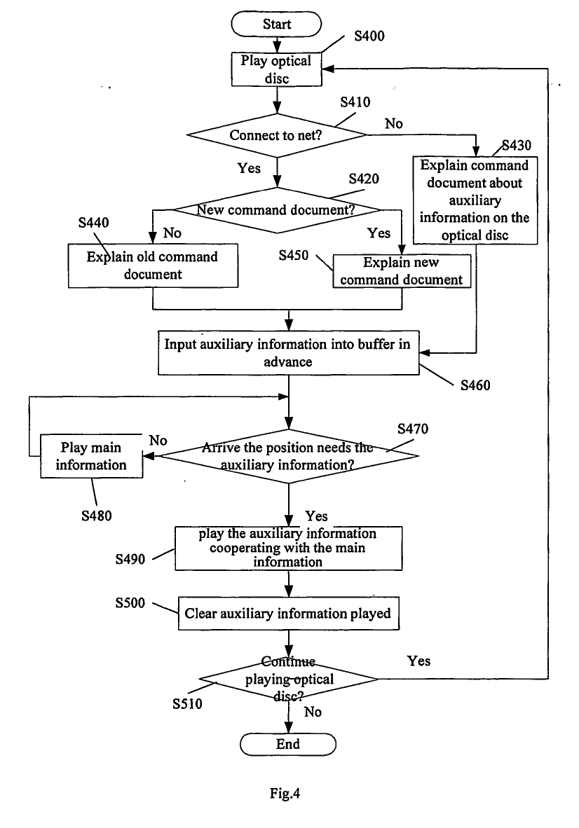

FIG. 4 shows the flow chart of an embodiment of an optical disc playing method according to the present invention. The player 30 will play the optical disc (Step S400), and detect whether it is connected to the network (Step S410) in the process of playing the optical disc.

If it is found that the player 30 is not connected to the network after detection, explaining the command document (shown in FIG. 2) with respect to the auxiliary information on the optical disc in the command document 20 (Step S430), and inputting the downloaded auxiliary information or the auxiliary information on the optical disc into the buffering management device 33 (shown in FIG. 3) in advance according to the instruction of the explained command document 20. If it is found that the player 30 is connected to the network after detection, detecting whether there is new version of the command document 20 (Step S420), because once the optical disc is published, the content supplier of the optical disc or other cooperators authorized by the content supplier may provide the information for new entertainment or better playing performance, and thus change the command document 20 accordingly.

If there is no new command document 20 on the network, explaining the old command document 20 stored on the optical disc, including the command document 21 with respect to the auxiliary information on the optical disc and the command document 22 with respect to the auxiliary information on the network (Step S440). If there is new command document 20 on the network, explaining the new command document 20, including the command document 21with respect to the auxiliary information on the optical disc and the command document 22 with respect to the auxiliary information on the network (Step S450).

Subsequently, according to the instruction of the explained command document 20, inputting the downloaded auxiliary information or the auxiliary information on the optical disc in advance into the buffering management device 33 (shown in FIG. 3) (Step S460).

The above process of inputting the auxiliary information into the buffering management device 33 is instructed by the explained command document 20 as to inputting what auxiliary information at which time spot, and these time spots locate at any time before the corresponding auxiliary information actually coordinates playing the main information of the optical disc.

Then, detecting whether the playing of the main information of the optical disc reaches the time spot (or position) where the corresponding auxiliary information is needed to cooperate to play (Step S470). If it has not reached the time spot (or position) where the main information needs the auxiliary information to cooperate to play, the player will continue playing the main information of the optical disc (Step S480), and then detecting again whether the playing of the main information of the optical disc reaches the time spot (or position) where the main information needs the auxiliary information to cooperate to play (Step S470); If it has reached the time spot (or position) where the main information needs the auxiliary information to cooperate to play, the player will read out the corresponding auxiliary information input into the buffering management device 33 in advance. Then play the auxiliary information cooperating with the main information of the optical disc synchronously (Step S490).

After finishing playing the auxiliary information in the buffering management device 33, the played auxiliary information will be cleared timely according to the instruction of the command document 20 (Step S500).

In the end, detecting whether to continue playing the optical disc (Step S510), and if the player continues playing the optical disc, it will return to continue playing the optical disc (Step S400) and repeat the previous steps; if the player does not need to continue playing the optical disc, it will end playing.

The above discussed is merely one embodiment according to the present invention, furthermore, the playing method according to the present invention can also implement the following steps,

(1) If the auxiliary information which is relate d to the command document and is needed to be input into the buffering management device 33 has existed in the local memory device of the player 30 such as the hard disk or other local devices, the auxiliary information will not need to be input into the buffering management device 33 (i.e. there is no process of inputting the auxiliary information into the buffering management device 33), but it will be directly read out from the hard disk or other devices and be played in coordination with the main information of the optical disc.

(2) If it is detected that the speed of the network is not fast enough, other measures, which can be realized by the strategies provided by the command document, will be adopted (e.g. waiting to retry, giving up and switching to the backup auxiliary information).

(3) If the speed of the player is not fast enough, other measure s, which can be realized by the strategies provided by the command document, will be adopted. For example, when the processor speed of the player 30 exceeds 500 MIPS, the input auxiliary information is JAVA application programs, while only pictures are input when the processor speed is less than 500 MIPS.

The optical disc, the player of the optical disc and the playing method thereof according to the present invention, instruct to input the auxiliary information into the buffering management device in advance by explaining the command document stored on the optical disc by the player during playing of the optical disc, so as to coordinate the synchronized playing of the main information of the optical disc and realize a fluent playing.

While the present invention has been described with reference to the particular embodiments, various substitutions, modifications and changes are apparent for those skilled in the art. Therefore, the present invention includes all such substitutions, modifications and changes within the spirit and scope defined by the following claims.

1. A method for playing an optical disc, comprising the steps of:
(a) explaining a command document;
(b) reading an auxiliary information in advance according to the explained command document to cooperate to play corresponding main information of the optical disc; and
(c) playing the corresponding main information cooperating with the auxiliary information read in advance when the auxiliary information is needed.

2. The method for playing an optical disc according to claim 1, wherein the auxiliary information read in advance is input into a buffering management device in advance.

3. The method for playing an optical disc according to claim 1, wherein the information read in advance includes at least one of the auxiliary information which is downloaded from network or read directly from the optical disc.

4. A method for playing an optical disc, comprising the steps of:
(a) obtaining position of the main information which needs the auxiliary information to cooperate to play;
(b) reading the auxiliary information in advance; and
(c) playing the main information cooperating with the auxiliary information read in advance at the position.

5. The method for playing an optical disc according to claim 4, further including explaining a command document.

6. The method for playing an optical disc according to claim 5, wherein in step (a) the position of the main information which needs the auxiliary information to cooperate to play is obtained according to the explained command document

7. The method for playing an optical disc according to claim 5, wherein in step (b) obtaining the auxiliary information read in advance according to the explained command document.

8. The method for playing an optical disc according to claim 4, wherein reading the auxiliary information in advance is implemented as inputting the auxiliary information into a buffering management device in advance.

9. An optical disc player, comprising:
an explaining device for explaining a command document; and
a buffering management device for obtaining the auxiliary information in advance according to the explained command document to cooperate to play the main information of the optical disc subsequently.

10. The player according to claim 9, further including a network management device for detecting whether there is the updated command document on the network.

11. An optical disc, including the main information and the auxiliary information stored separately from the main information, characterized in that the optical disc also includes a part for instructing to play the main information cooperating with the auxiliary information.

12. The optical disc according to claim 11, wherein the part includes a command document.

13. The optical disc according to claim 11, wherein the command document includes an ID corresponding to a playing list when playing the main information of the disc cooperating with the auxiliary information, the time spot when inputting the auxiliary information described by a physical command information into a buffer of a player and the time spot when clearing up the auxiliary information from the buffer.

14. The optical disc according to claim 13, wherein the command document also includes the URL used as a backup, the strategy for solving the problems that the size of the information contained in the physical command information is too small and that the speed of net is not fast enough, the strategy for matching with the state of the player and the aim buffering zone into which the physical command document needs to be input.
